(19) United States
(12) Patent Application Publication
(10) Pub. No.: US 2009/0032471 A1
(43) Pub. Date: Feb. 5, 2009

(54) Innovative treatment technologies for reclaimed water

(75) Inventor: Charles Borg, San Francisco, CA (US)

Correspondence Address: King & Spalding LLP, P.O. Box 889, Belmont, CA, 94002-0889, US

(73) Assignee: Applied Process Technology, Inc., Pleasant Hill, CA (US)

(21) Appl. No.: 12/220,933

(22) Filed: Jul. 29, 2008

Related U.S. Application Data
(60) Provisional application No. 60/962,679, filed on Jul. 30, 2007.
(60) Provisional application No. 61/008,265, filed on Dec. 18, 2007.

(51) Int. Cl. C02F 9/00; C02F 9/04; C02F 9/02; C02F 9/12

(52) U.S. Cl. 210/650

(57) ABSTRACT

Innovative methods and systems for the removal and destruction of contaminants present in reclaimed or other waste water are described.

The present application claims priority to U.S. Provisional Patent Application Ser. Nos. 60/962,679, filed on Jul. 30, 2007, and 60/008,265, filed on Dec. 18, 2007, which are hereby incorporated by reference in their entirety.

### TECHNICAL FIELD

The present methods and systems relate to the removal and destruction of contaminants present in reclaimed or other waste water.

### BACKGROUND

One way to reduce the demand for fresh water is to reclaim waste water for human and animal consumption and other uses. However, public concerns over residual endocrine disrupting compounds (EDCs), pharmaceutically active compounds (PhaCs), pathogens, and other contaminants, limit the acceptance of reclaimed water. Of notable concern are organic contaminants such as ethynyl estradiol, triclosan, DEET, surfactants, and bisphenol-A., and organism/pathogen contaminants such as Cryptosporidium, poliovirus, and coliforms. The thorough removal of these and other contaminants increases the cost of reclaiming waste water, particularly using convention water treatment methods, such as reverse osmosis (RO), ultrafiltration (UF), and advanced oxidative procedures (AOP), where the cost of setting up a 1-million gallon-per-day (1 meg gpd) treatment facility is on the order of $10 meg USD.

The need exists for more efficient and less expensive water treatment techniques that can adequately remove contaminants from waste water at a reasonable cost.

### SUMMARY

The following aspects and embodiments thereof described and illustrated below are meant to be exemplary and illustrative, not limiting in scope.

In one aspect, an improved method for removing contaminants from reclaimed waste water is provided, the contaminants selected from organic compounds, bacteria, and viruses, the method including the steps of:

(a) exposing the reclaimed water to a treatment method selected from the group consisting of ozone treatment or ultra-violet (UV) treatment;

(b) exposing the reclaimed water to hydrogen peroxide; and

(c) exposing the reclaimed water to pressurized microfiltration;

wherein the combination of steps (a)-(c) produces treated reclaimed waste water having a substantial reduction in each contaminant.

In some embodiments, (a) is ozone treatment effective for removing bacteria and viruses, and exposing the reclaimed water to hydrogen peroxide in (b) is for reducing bromate formed in (a).

In some embodiments, (a) is ozone treatment effective for removing organic compounds selected from the group consisting of nonylphenol (NP), triclosan (TCS), and Bisphenol-A (BPA).

In some embodiments, (a) is UV treatment effective for removing viruses, and exposing the reclaimed water to hydrogen peroxide in (b) is for reducing bromate formed in (a).

In some embodiments, (a) is UV treatment effective for removing viruses, and exposing the reclaimed water to hydrogen peroxide in (b) is for reducing organic compounds selected from estradiol equivalents (EEQ), and N-nitrosodimethylamine (NDMA).

In another aspect, an improved method for removing contaminants from reclaimed waste water is provided, the contaminants selected from organic compounds, bacteria, and viruses, the method including the steps of:

(a) exposing the reclaimed water to a treatment method selected from the group consisting of peracetic acid (PAA)/ultra-violet (UV) treatment and UV/peroxide treatment;

(b) exposing the reclaimed water to ozone; and

(c) exposing the reclaimed water to pressurized microfiltration;

wherein the combination of steps (a)-(c) produce treated reclaimed waste water having a substantial reduction in each contaminant.

In some embodiments, the ozone exposure in (b) reduces total coliforms to the level required by Title 22 of the California Code of Regulations.

In some embodiments, the ozone exposure in (b) reduces total coliforms to 2.2 MPN per 100 mL or less.

In yet another aspect, a business method for reclaiming waste water is provided, comprising

(a) obtaining waste water;

(b) performing the method for removing contaminants from reclaimed waste water described, herein; and

(c) offering for sale the treated reclaimed waste water.

In some embodiments, the treated reclaimed water is offered at a price less than cost of performing steps (a)-(c).

In a related aspect, a business method for reclaiming waste water is provided, comprising

(a) obtaining waste water;

(b) performing the method for removing contaminants from reclaimed waste water described, herein; and

(c) offering for sale the treated reclaimed waste water of step (b).

In some embodiments, the treated reclaimed waste water is offered at a price less than cost of performing steps (a)-(c).

In another aspect, treated reclaimed waste water produced by one or more of the present method and/or systems are provided.

These and other objects and features of the invention are made more fully apparent in the following detailed description of the invention.

### BRIEF DESCRIPTION OF THE DRAWINGS

FIG. 1 is a graph showing particle size distribution in untreated and treated water.

FIG. 2 is a table showing the efficiency of microfiltration and sand filtration in removing waterborne contaminants from waste water.

FIG. 3 is a graph showing the effect of ozone, peroxide, and filtration on virus removal.

FIG. 4 is a graph showing the effect of ozone and peroxide levels on the efficiency of coliform removal.

FIG. 5 is a graph showing the effect of ozone levels on bromate formation.

FIG. 6 is a graph showing the effect of ozone levels on the removal of select contaminants, such as nonylphenol (NP), triclosan (TCS), and bisphenol-A (BPA).

FIG. 7 is a graph showing the effect of ozone levels and filtration methods on EEQ destruction.

FIG. 8 is a graph showing the effect of peroxide levels on EEQ destruction.

FIG. 9 is a graph comparing the efficiency of several treatment methods in reducing NDMA levels.

FIG. 10 is a graph comparing the construction costs of different water treatment facilities.

### DETAILED DESCRIPTION

### I. Overview

Described are data and observations obtained from several pilot studies involving the decontamination of regional waters. The pilot studies were designed to test the efficacy of different water treatment methods and systems using different contaminated regional waters, with the goal of informing an accurate prediction of the cost of full-scale implementation for such effective methods and systems.

Based in part on these pilot studies, it was surprisingly found that ozone and UV-based water treatment methods, combined with peroxide treatment and microfiltration, can adequately decontaminate, and in some cases disinfect, waste water at a fraction the cost of conventional methods.

### II. Pilot Tests

Several water treatment techniques were compared, including ozone and ozone/peroxide, ultra-violet (UV) and UV/peroxide, and peracetic acid (PAA) and PAA with UV and or peroxide. The water-borne contaminants measured included viruses, bacteria, protozoa, EDCs, PhaCs, and disinfection byproducts (DBPs). A list of the contaminants and other water properties examined or measured is provided in Table 1.

TABLE 1
List of contaminants examined

| Organism | Metal | DBP | EDCs/PhAC | Other |
|---|---|---|---|---|
| Giardia | As | Bromate | NDMA | BOD |
| Cryptosporidium | Cd | Bromide | Atrazine | TSS |
| Total Coliform | Cr | HAA5 | Bisphenol-A | pH |
| Fecal Coliform | Cu | Monochloroacetic acid | Hormone suite | Alkalinity |
| Adenovirus | Hg | Dichloroacetic acid | | TOC |
| MS2 Phage | Ni | Trichloroacetic acid | | Turbidity |
| | Pb | Bromochloroacetic acid | | Nitrate |
| | Se | Dibromoacetic acid | | Ammonia |
| | Zn | TTHMs | | Phosphate |
| | Ag | Bromoform | | Kjeldahl nitrogen |
| | | Chloroform | | |
| | | Chlorodibromomethane | | |

Three pilot tests are described, below. The first was conducted at the Dublin San Ramon Services District (DSRSD) in Dublin, Calif., USA; the second was conducted at the Pinellas County water treatment facility in Clearwater, Fla., USA; and the third was conducted at the Bradenton Wastewater Treatment facility in Bradenton, Fla., USA. The design and results of these studies are to be described.

A. Ozone/Peroxide Pilot at DSRSD

A first pilot study was performed at the Dublin San Ramon Services District (DSRSD) in Dublin, Calif., USA to determine the impact of different ozone treatment levels (i.e. dose), the effect of peroxide addition, and the effect of influent water quality, on contaminant removal using an ozone-based system.

Influent water was treated using a HiPOₓ reactor oxidation system in combination with either a microfiltration device or a sand filter. The HiPOₓ reactor was a 10 gallon-per-minute (GPM) plug-flow-type reactor, which included hydrogen peroxide and ozone injection points (Applied Process Technologies, Inc.; Pleasant Hill, Calif., USA). The HiPOₓ process combines ozone (O₃) and hydrogen peroxide (H₂O₂) to form hydroxyl radicals that destroy organic compounds present in influent water, while controlling bromate formation characteristic of high ozone levels. Effluent from the HiPOₓ reactor was then filtered using either a pressurized 0.2 μm pore size microfilter (Memcor 9010 MC; Derbyshire, UK) or a continuous backwash upflow sand filter with a nominal sand media diameter of 1.27-1.38 millimeters and a media depth of 80 inches (Andritz; Muncy, Pa., USA).

Table 2 shows the test conditions used in the first part of the study. Influent water was treated in the HiPOₓ reactor with ozone only (Test Run A); ozone and 1 mg/L hydrogen peroxide (Test Run B); or ozone and 3 mg/L hydrogen peroxide (Test Run C); followed by either pressurized microfiltration (microfiltration) or sand filtration (media).

TABLE 2
Test conditions used in the DSRSD pilot

| | Ozone | | Ozone | | Ozone | |
|---|---|---|---|---|---|---|
| Flow | dose | H₂O₂ dose | dose | H₂O₂ dose | dose | H₂O₂ dose |
| (gpm) | (mg) | (mg) | (mg) | (mg) | (mg) | (mg) |
| | Test Run A - post | | Test Run B - post | | Test Run C - post | |
| | microfiltration¹ | | microfiltration¹ | | microfiltration¹ | |
| 10 | 0 | 0 | 0 | 1 | 0 | 3 |
| 10 | 1 | 0 | 1 | 1 | 1 | 3 |
| 10 | 3 | 0 | 3 | 1 | 3 | 3 |
| 10 | 5 | 0 | 5 | 1 | 5 | 3 |
| 10 | 10 | 0 | 10 | 1 | 10 | 3 |
| | Test Run A - post | | Test Run B - post | | Test Run C - post | |
| | media | | media | | media | |
| 10 | 0 | 0 | 0 | 1 | 0 | 3 |
| 10 | 1 | 0 | 1 | 1 | 1 | 3 |
| 10 | 3 | 0 | 3 | 1 | 3 | 3 |
| 10 | 5 | 0 | 5 | 1 | 5 | 3 |
| 10 | 10 | 0 | 10 | 1 | 10 | 3 |

¹No indigenous organism testing post microfiltration after ozone doses of 5 mg/L

The filtered effluent water was analyzed for particle size distribution (PSD), biochemical oxygen demand (BOD), pH/alkalinity, total suspended solids (TSS), turbidity, nitrate levels, ammonia levels, and phosphate levels, all of which reflect water quality.

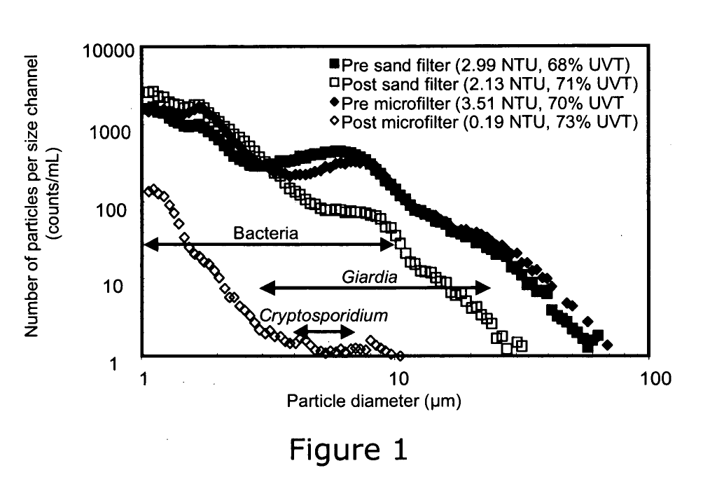

As shown in FIG. 1, the post microfiltration effluent contained substantially fewer particles of smaller particle size than the pre-filtered water. Sand filtration removed larger particles but was significantly less effective than microfiltration. The particle size ranges of bacteria, Giardia, and Cryptosporidium are shown superimposed on the graph in FIG. 1. Microfiltration provided a measurable microbiological barrier to particles in the size range of Giardia, Cryptosporidium, and bacteria, while no substantial removal of such particles was observed with the sand filter.

The results of a more detailed analysis of the number of organisms present in microfiltered (MF) and sand-filtered (sand) effluents are shown in Table 3. The Table indicates the number of virus particles (i.e., indigenous male-specific coliphage) in plaque forming units (PFU) per liter, Cryptosporidium (Crypto) cysts per liter, Giardia cysts per liter, and bacteria (total coliforms and fecal coliforms) as most probable number (MPN)/100 ml. The Table also indicates turbidity in nephelometric turbidity units (NTU) and total suspended solids (TSS) in mg/L.

TABLE 3
Organisms present in filtered effluents

| | | | | Total | Fecal | | |
|---|---|---|---|---|---|---|---|
| | Coli- | | | coli- | coli- | Tur- | |
| | phage | Crypto | Giardia | forms | forms | bidity | TSS |
| Sand | Negl. | Negl. | Negl. | 20 | 71 | 35 | 51 |
| MF | Negl. | 94 | 98 | 99 | 99 | 95 | 99 |

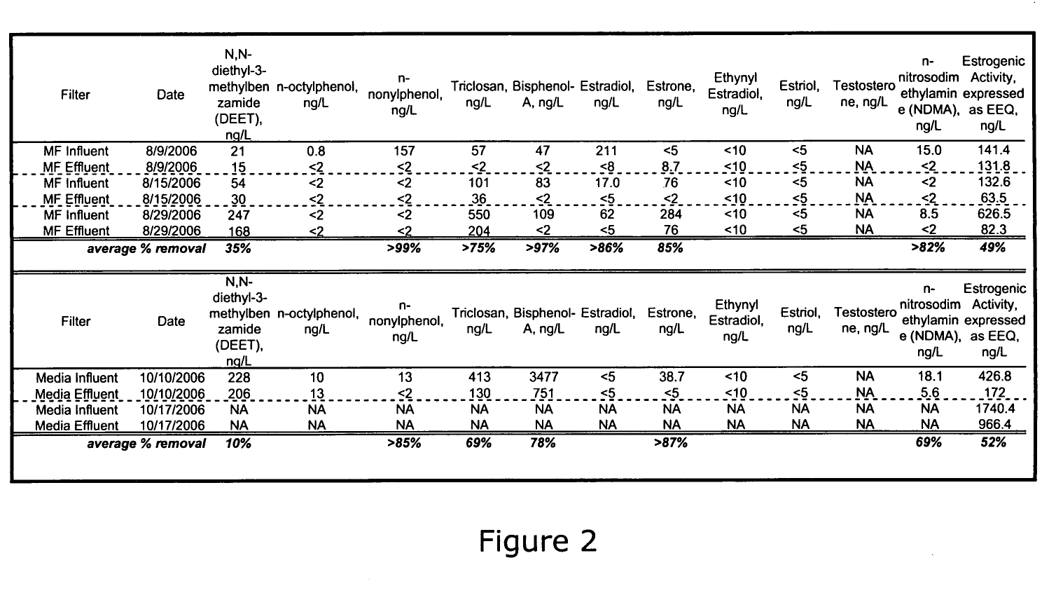

The Table in FIG. 2 shows the efficiency of microfiltration and sand filtration in removing various other waterborne contaminants (microconstituents) from influent water. The data shown that microfiltration is more efficient than sand filtration in removing such contaminants as DEET, n-nonylphenol, triclosan, and bisphenol-A.

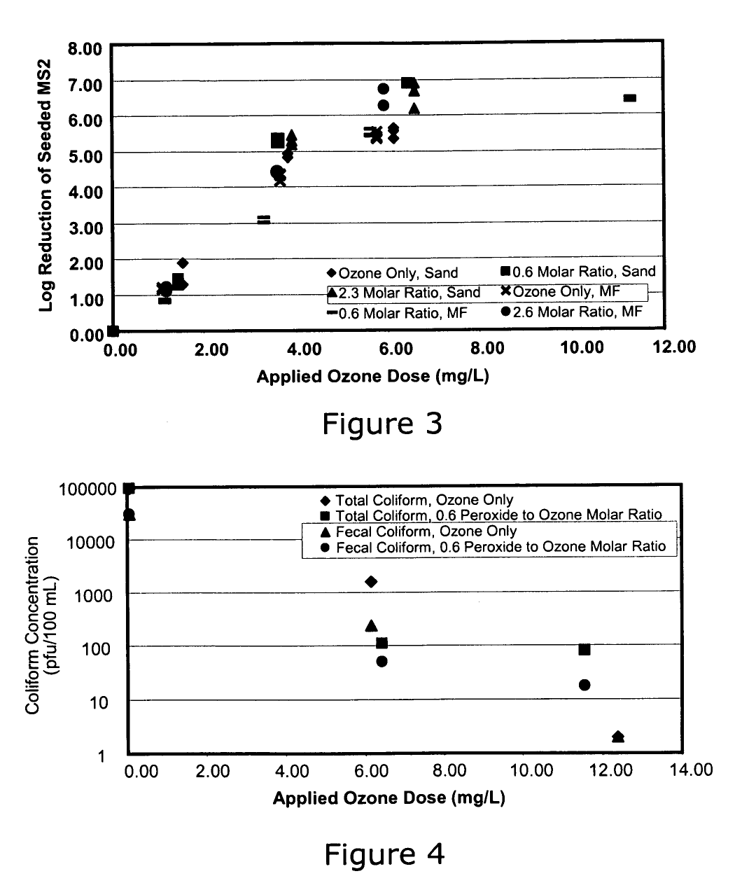

Experiments also demonstrated the relative importance of ozone and peroxide levels (i.e., doses) in removing contaminants. For example, the graph in FIG. 3 shows that virus removal is dependent on the applied ozone level but is not affected by peroxide addition or the selection of filtration means. Similarly, as shown in FIG. 4, coliform removal is affected by high ozone levels but not by peroxide addition. Notably, the effective removal of coliforms may require higher levels of ozone than required for removal of viruses.

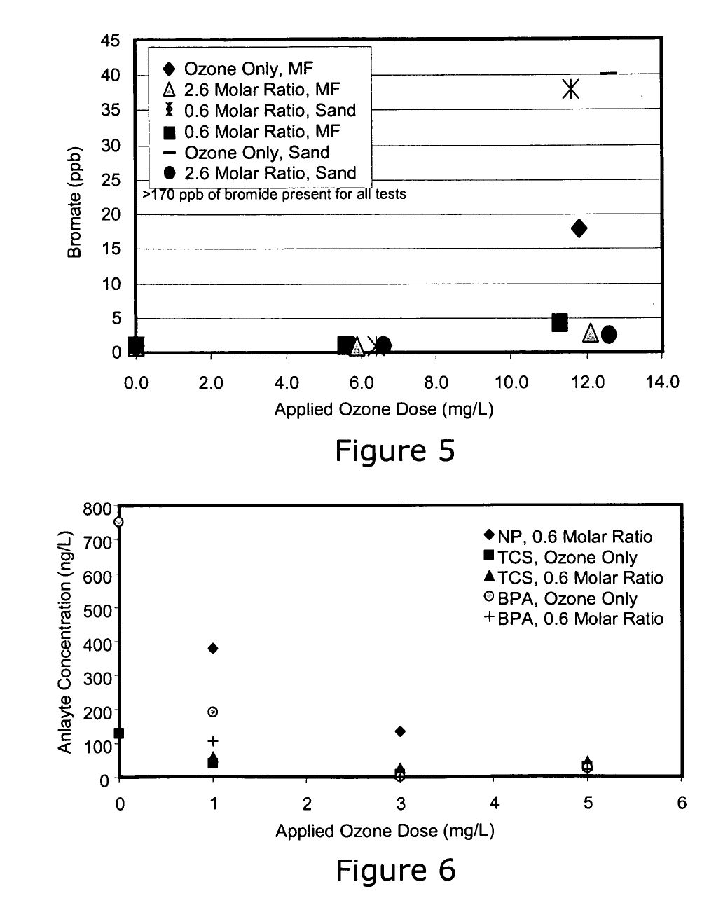

As shown in FIG. 5, a disadvantage to the use high levels of ozone is encouragement of bromate formation. However, removal of bromate can be accomplished using peroxide. Bromate formation and removal are unaffected by filtration.

Ozone provides substantial destruction of select organic contaminants, such as nonylphenol (NP), triclosan (TCS), and bisphenol-A (BPA), as shown in FIG. 6.

These results show that HiPOₓ, treatment can be coupled with microfiltration to effectively remove both organic compounds and pathogens from contaminated water.

B. UV/Peroxide Pilot at Pinellas County

A second pilot study was performed in Pinellas County Clearwater, Fla., USA, to determine the impact of UV dose and peroxide addition on contaminant removal. The UV Reactor at Pinellas County was a Trojan (London, Ontario, Canada) UV Logic 30AL50A reactor equipped with 30 low-pressure, high-output (LPHO) UV lamps and a H₂O₂ injection system. The test plan for the Pinellas County pilot is shown in Table 4. The particular emerging pollutants of concern (EPOC) in this study were estradiol compounds, measured as estradiol equivalents (EEQ), and the potent carcinogen N-nitrosodimethylamine (NDMA).

TABLE 4
Test plan for the Pinellas County pilot

| | Target | | | H₂O₂ | |
|---|---|---|---|---|---|
| | UV dose | | Target EPOC | dose | Flow |
| Test ID | (mJ/cm2) | UVT (%) | destruction | (mg/L) | (gpm) |
| A | 100 | 65 | not targeted | 0 | 775 |
| B | 100 | 65 | not targeted | 5 | 775 |
| C | 100 | 65 | not targeted | 10 | 775 |
| D | 100 | 55 | not targeted | 0 | 575 |
| E | 100 | 55 | not targeted | 5 | 575 |
| F | 100 | 55 | not targeted | 10 | 575 |
| G | not targeted | 65 | 90% NDMA | 0 | 45 |
| H | not targeted | 65 | 90% NDMA | 5 | 45 |
| I | not targeted | 65 | 90% NDMA | 10 | 45 |
| J | not targeted | 65 | 90% NDMA | 25 | 45 |
| K | not targeted | 55 | 90% NDMA | 0 | 140 |
| L | not targeted | 55 | 90% NDMA | 5 | 140 |
| M | not targeted | 55 | 90% NDMA | 10 | 140 |
| N | not targeted | 55 | 90% NDMA | 25 | 140 |

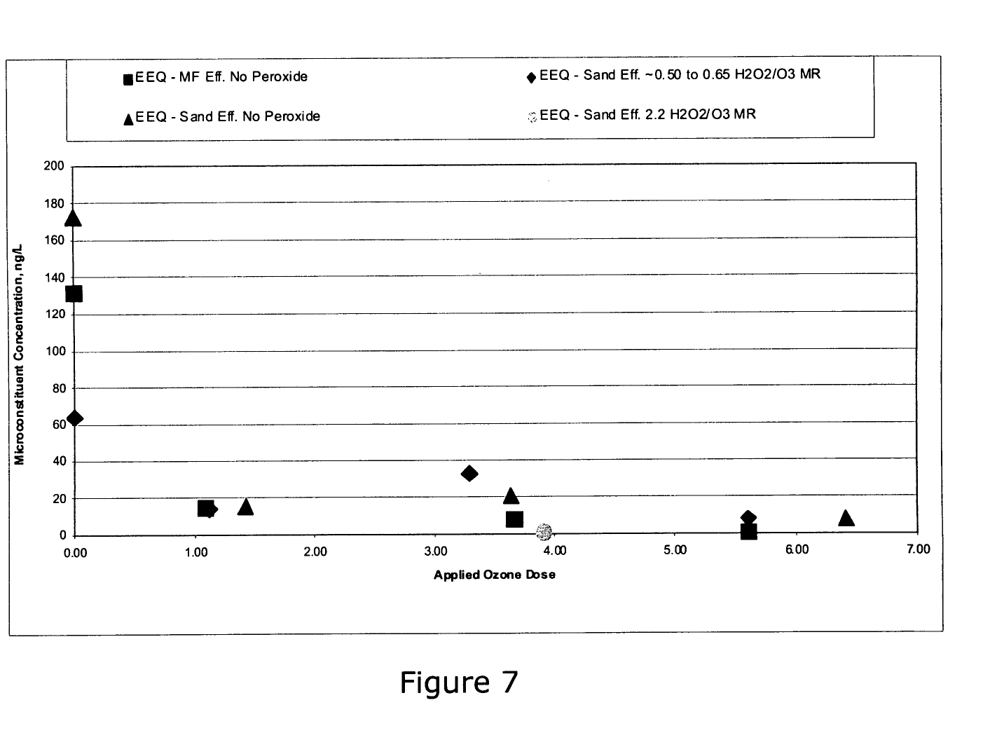

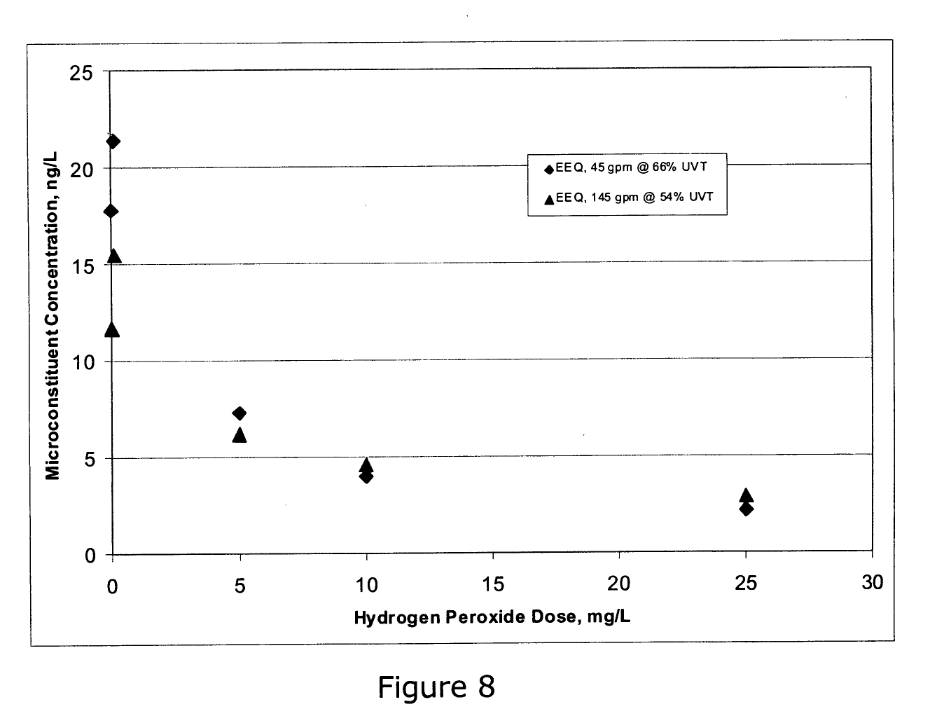

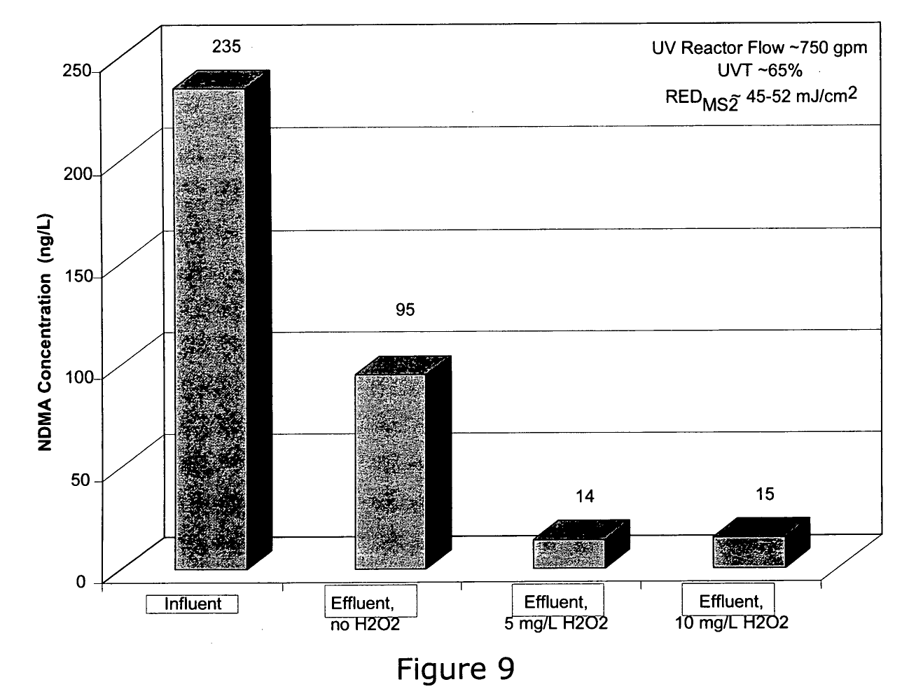

Results relating to the destruction of EEQ are shown in FIGS. 7 and 8. Increasing levels of ozone produced increased destruction of EEQ, while the type of filtration had little effect (FIG. 7). Increasing the levels of peroxide also resulted in increased destruction of EEQ, while the amount of UV exposure appeared to have minimal effect on EEQ destruction (FIG. 8). Both UV treatment and peroxide treatment reduce the levels of NDMA in effluent water (FIG. 9). Increasing the peroxide level above 5 mg/L appears to minimally increase the destruction of NDMA, suggesting that optimal efficiency can be achieved at moderate peroxide levels.

As shown in Table 5, peroxide did not impact UV disinfection of virus particles, since increasing amounts of peroxide failed to further reduce the levels of MS2 phage compared to UV treatment alone.

TABLE 5
Effect of H₂O₂ on UV disinfection

| | | | | Lower 75th percentile |
|---|---|---|---|---|
| | | | H₂O₂ | delivered dose |
| | Flow | Average | addition | based upon |
| Test ID | (gpm) | UVT (%) | (mg/L) | MS2 model (mJ/cm2) |
| A | 750 | 65.6 | 0 | 45 |
| B | 750 | 63.7 | 5 | 49 |
| C | 743 | 64.3 | 10 | 52 |

These results show that UV treatment for virus destruction can be combined with ozone and/or peroxide treatment for EEQ and NDMA destruction, to provide an effective treatment system for decontaminating waste water.

C. PAA/UV, UV/Peroxide, and Ozone Pilot at Bradenton

A third pilot study was performed at the Wastewater Treatment facility in Bradenton, Fla., USA. to determine the impact of peracetic acid (PAA)/UV and UV/peroxide addition on contaminant removal. The study was designed much like studies A and B, above, and demonstrated that microfiltration following PAA/UV or UV/peroxide treatment, provided a substantially better microorganism barrier than sand filtration.

The study also demonstrated that the addition of ozone treatment at high doses satisfied the coliform criteria of Title 22 of the California Code of Regulations (i.e., 2.2 MPN per 100 mL for total coliforms). Ozone treatment at even moderate doses provided substantial virus destruction.

Ozone and ozone/peroxide treatment provided substantial destruction of contaminant and peroxide further reduced disinfection byproducts (DBP). In addition to having an antimicrobial affect, even low levels of UV treatment may promote hydroxyl radical formation, which increases the destruction of other contaminants.

The results of the third pilot suggested that combinations of UV/ozone/peroxide treatments can be used to remove a diverse range of contaminants from reclaimed water, for example, by taking advantage of the decontamination properties of each treatment, and by exploiting the formation of hydroxyl radicals produced by UV/peroxide and ozone/peroxide combinations.

### III. Summary of Results

The described pilot studies were designed to determine the most effective processes for reclaiming waste water and inform a reasonable cost estimate for full-scale implementation of such technologies for on-site water treatment. The pilot studies addressed the removal of numerous types of water-borne contaminants, including organic contaminants such as DBPs, EEQs, EDCs/PhACs, and bromate, and pathogens/microorganism.

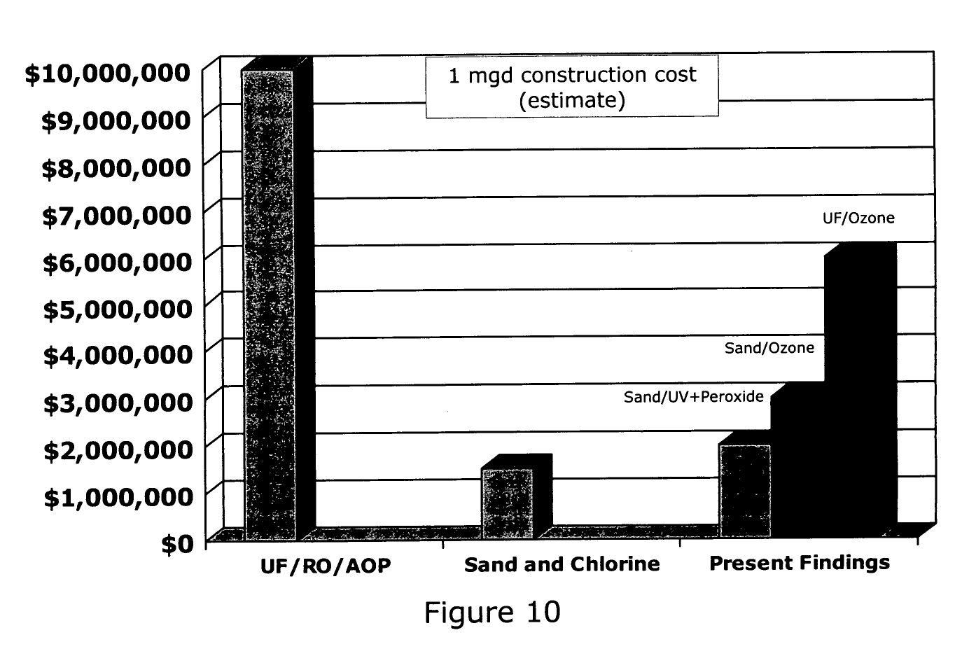

Based on the pilot studies, a cost estimate for setting up a 1-million gallon-per-day treatment facility was prepared. A comparison of the cost of setting up different types of treatment facilities is shown FIG. 10. While water treatment using sand and chlorine is the least expensive method of water decontamination, the limited ability of sand to filter microcontaminants and the undesirable taste and odor associated with chlorine limit the efficacy of the method. On the other hand, while conventional ultrafiltration (UF), reverse osmosis (RO), and advanced oxidative procedures (AOP) are more effective in removing contaminants without imparting undesirable taste and odor, the cost of these methods and systems can be prohibitive.

The present pilot studies suggest that ozone and UV-based water treatment methods, combined with peroxide treatment and microfiltration, can adequately decontaminate waste water at a fraction the cost of conventional methods. These studies empirically demonstrate the efficacy of combinations of water treatment techniques that can substitute for conventional methods are a fraction the cost. Business methods for reclaiming waste water for human and/or animal consumption or other uses, based on the water treatment methods and systems, are also provided.

### IV. Ozone Dissolution and HiPOx™

The ozone dissolution processes involves the introduction and dissolution of ozone into water to oxidize contaminants to less harmful compounds. Variations of the ozone dissolution process utilize ozone, oxygen, air (which includes oxygen), ozone and oxygen, ozone and air, oxygen and air, or ozone, oxygen and air, as gas oxidants.

High pressure oxidation (HiPOx™) involves oxidation of organic contaminants under pressure using the oxidants ozone and hydrogen peroxide (H₂O₂). The amount of pressure is generally not critical, so long as the oxidants are delivered at sufficient levels and mixed sufficiently well to achieve the desired amount in decontamination or disinfection. In some cases, the HiPOx™ process requires only seconds for efficient contaminant removal, avoiding the need for prolonged residence times. Variations on the HiPOx™ method utilize ozone, oxygen, ozone/oxygen, air, ozone/air, oxygen/air, or ozone/oxygen/air, which are collectively referred to as oxidant (or oxidizing) gasses, in combination with hydrogen peroxide.

The selection of particular gas oxidant(s) for use in a ozone dissolution or HiPOx™, and the levels of such oxidants, largely depends on the types and levels of contaminants present in the influent water, the additional decontamination process operations that are used in combination with the present apparatus, systems, and methods, and the proposed use of the decontaminated water. These aspects of decontamination and disinfection are explored in greater detail, above.

An excess of ozone may be used, such that residual ozone present in the decontaminated water is available to interact with additional contaminants present water or soil in or around a well or opening in a water table. In addition to the ozone, oxygen, and air, any volume of inert gas (e.g., nitrogen) can be injected into the contaminated ground water to mix and distribute the oxidants. The levels of oxidizing agents may also be adjusted to minimize the precipitation of iron and other minerals (i.e., plugging), which occurs in the presence of excess oxygen.

Where HiPOx™ is used, excess hydrogen peroxide may be used where bromate formation is an issue. Bromate formation can also be controlled via pH adjustment and/or the addition or chlorine or ammonia. Conversely, an excess of ozone, or both ozone and hydrogen peroxide, may be used to ensure that discharged (treated) water includes residual oxidants to promote further decontamination, even downstream of the treatment apparatus.

### V. UV Treatment

As shown in the following Table, ultraviolet energy/light is classified into three wavelength ranges:

| Type of UV Energy | Wavelength |
|---|---|
| UV-A | 315 nm to 400 nm. |
| UV-B | 280 nm to 315 nm |
| UV-C | 200 nm to 280 nm |

UV-C energy is the most germicidal, which is presumably the result DNA damage to microorganisms, including bacteria and viruses. Preferably, UV energy used for water treatment has a wavelength of between about 250 to about 260 nm, including 254 nm. The UV energy dose (also called “fluence”) is measured as the product of UV energy intensity multiplied by the exposure time. Conventionally, exposure to about 20 to about 34 milliWatt-seconds per square centimeter (mW-s/cm²) UV energy kills 99% of pathogens, although the above pilot studies provide additional details. Fluence may also be expressed in terms of milliJoules/cm² or Joules/m². Note that Watts (W) are equivalent to Joules/second.

Any suitable UV radiation source can be used in water treatment systems. Low, medium, and high, and ultra-high pressure lamps made of various materials, most commonly comprising mercury (Hg), are commonly used for UV disinfection. In one example, the UV energy source is a low pressure mercury vapor arc lamp with peak energy output at 254 nm, such as a Philips Model TUV PL-S 38W4P lamp. In another example, the UV energy source is a mercury-argon Hg(Ar) UV lamp, such as the Oriel Instruments, model 6035 lamp. Another suitable UV energy source is a Fusion RF UV lamp, commercially available from Fusion UV Systems, Inc. Various germicidal UV lamps are sold by North American Philips Lighting, including the Model Nos. 782L-30 and G37TVH lamps.

Fluence generally varies within a volume of water being treated, e.g., due to energy attenuation and dissipation. Water positioned farther from the UV energy source is exposed to less UV energy since energy is dissipated as light passes through water. The clarity of the water being treated also influences the dissipation of energy. Clearer water more readily transmits light energy. UV water treatment systems are preferably designed such that the lowest fluence received by any of the water being treated is sufficient to achieve the desired level of disinfection.

An absorption coefficient (a) describes how much light is absorbed per centimeter path length as it travels through a water treatment sample. As the absorption coefficient increases, transmissivity decreases exponentially. Absorption coefficients are typically reported in inverse centimeters (cm⁻¹), and can be determined empirically. The absorption coefficient of pure distilled water is close to zero. The absorption coefficient of drinking water is typically from about 0.01 to 0.2 cm⁻¹.

Modifications and variation on the present methods will be apparent to the skilled artisan in view of the present description without departing from the spirit and scope of the invention.

What is claimed is:

1. An improved method for removing contaminants from reclaimed waste water, the contaminants selected from organic compounds, bacteria, and viruses, the method including the steps of:
(a) exposing the reclaimed water to a treatment method selected from the group consisting of ozone treatment or ultra-violet (UV) treatment;
(b) exposing the reclaimed water to hydrogen peroxide; and
(c) exposing the reclaimed water to pressurized microfiltration;
wherein the combination of steps (a)-(c) produces treated reclaimed waste water having a substantial reduction in each contaminant.

2. The method of claim 1, wherein (a) is ozone treatment effective for removing bacteria and viruses, and exposing the reclaimed water to hydrogen peroxide in (b) is for reducing bromate formed in (a).

3. The method of claim 1, wherein (a) is ozone treatment effective for removing organic compounds selected from the group consisting of nonylphenol (NP), triclosan (TCS), and Bisphenol-A (BPA).

4. The method of claim 1, wherein (a) is UV treatment effective for removing viruses, and exposing the reclaimed water to hydrogen peroxide in (b) is for reducing bromate formed in (a).

5. The method of claim 1, wherein (a) is UV treatment effective for removing viruses, and exposing the reclaimed water to hydrogen peroxide in (b) is for reducing organic compounds selected from estradiol equivalents (EEQ), and N-nitrosodimethylamine (NDMA).

6. An improved method for removing contaminants from reclaimed waste water, the contaminants selected from organic compounds, bacteria, and viruses, the method including the steps of:
(a) exposing the reclaimed water to a treatment method selected from the group consisting of peracetic acid (PAA)/ultra-violet (UV) treatment and UV/peroxide treatment;
(b) exposing the reclaimed water to ozone; and
(c) exposing the reclaimed water to pressurized microfiltration;
wherein the combination of steps (a)-(c) produce treated reclaimed waste water having a substantial reduction in each contaminant.

7. The method of claim 6, wherein the ozone exposure in (b) reduces total coliforms to the level required by Title 22 of the California Code of Regulations.

8. The method of claim 6, wherein the ozone exposure in (b) reduces total coliforms to 2.2 MPN per 100 mL or less.

9. A business method for reclaiming waste water comprising
(a) obtaining waste water;
(b) performing the method of claim 1; and
(c) offering for sale the treated reclaimed waste water.

10. The business method of claim 9, wherein the treated reclaimed water is offered at a price less than cost of performing steps (a)-(c).

11. A business method for reclaiming waste water comprising
(a) obtaining waste water;
(b) performing the method of claim 6; and
(c) offering for sale the treated reclaimed waste water of step (b).

12. The business method of claim 11, wherein the treated reclaimed waste water is offered at a price less than cost of performing steps (a)-(c).

13. The method of claim 1, treated reclaimed waste water produced the method of claim 1.

14. The method of claim 1, treated reclaimed waste water produced the method of claim 6.
